(19) United States
(12) Patent Application Publication
(10) Pub. No.: US 2007/0294732 A1
(43) Pub. Date: Dec. 20, 2007

(54) Method and system for delivering on-demand video in an aircraft

(75) Inventors: Kenneth Arlen Brady, Trabuco Canyon, CA (US); David Anthony Reichert, Orange, CA (US); Lars Elof Rosenblad, Long Beach, CA (US); Harmon F. Law, Irvine, CA (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Thales Avionics, Inc., Irvine, CA (US)

(21) Appl. No.: 11/453,620

(22) Filed: Jun. 15, 2006

(51) Int. Cl. H04N 7/16; H04N 7/173

(52) U.S. Cl. 725/87; 725/86; 725/114; 725/144

(57) ABSTRACT

A system for providing on-demand video on an aircraft is described. In various implementations, the system includes a first computer that receives broadcast video content, digital video players distributed within a passenger seating area of the aircraft, and a second computer. The second computer receives the video content from the first computer, and provides the video content, on-demand, to a subset of the digital video players. The system also includes a third computer that receives the video content from the first computer, and provides the video content, on-demand, to another subset of the plurality of digital video players. The first computer may provide the video content to the second and third computers using a multicast protocol. The video content may include a live television broadcast or a television channel that was requested by a user of one or more of the digital video players.

### TECHNICAL FIELD

This invention relates generally to aircraft-based on-demand video systems and methods, and, more particularly, to aircraft-based on-demand video systems and methods that permit both broadcasting and multicasting to occur.

### BACKGROUND

In recent years, cable and satellite television technologies have been combined with low-cost, high-capacity digital video recorders to give viewers a tremendous amount of flexibility regarding what programs are watched and when they are watched. The typical consumer is now accustomed to getting video on-demand (VOD). However, there are still certain types of content that entertainment networks would still like to broadcast real-time, such as live programs. But broadcasting content has certain inherent inefficiencies. For example, some viewers on a network may not wish to view a particular broadcast program, but instead may want to view a unicast, VOD program. One environment in which an audience is likely to include people who want broadcast content along with people who want VOD is on a passenger airline. For example, there may be many passengers on a flight who wish to watch the NCAA playoffs. At the same time, there may be passengers on the same flight who are not interested in basketball, but would rather watch VOD movie. But since the broadcast content is propagated throughout the network, bandwidth that could be devoted to VOD is wastefully consumed. Thus, it can be seen that there is a need for a method and system for delivering VOD that addresses the foregoing problems.

### SUMMARY

In accordance with the foregoing, a method and system for delivering on-demand video is provided. In an embodiment of the invention, the system includes a first computer that receives broadcast video content, digital video players distributed within a passenger seating area of the aircraft, and a second computer. The second computer receives the video content from the first computer, and provides the video content, on-demand, to a subset of the digital video players. The system also includes a third computer that receives the video content from the first computer, and provides the video content, on-demand, to another subset of the plurality of digital video players. The first computer may provide the video content to the second and third computers using a multicast protocol. The video content may include a live television broadcast or a television channel that was requested by a user of one or more of the digital video players.

In various implementations the first computer receives requests for the video content from each of a subset of the plurality of digital video players and, in response to the requests, subscribes to a multicast group for the video content.

The system may also include a network switch communicatively linked to the first, second, and third computers, wherein the network switch maintains a routing table, and the network switch routes communication from the first computer to both of the second and third computers based on the routing table.

In one implementation, the second computer only receives the video content from the first computer if the second computer has detected that there is a demand for the video content by one or more of the digital video players.

The system may also include a satellite receiver communicatively linked to the first computer, wherein the first computer receives satellite television video signals from the satellite receiver, and the satellite television video signals represent the video content. The digital video players to which the video content is transmitted may have previously requested the content.

In various embodiments, each of the digital video players executes software for presenting a menu to a passenger and receives, from the passenger, a request for the video content.

In another embodiment of the invention, the system includes a broadcast server that receives a live video feed and multicasts the content of the feed, video-on-demand servers communicatively linked to the broadcast server, and multiple groups of digital video players located in a passenger area of the aircraft. Each group of digital video players is associated with one video-on-demand servers. Each of the video-on-demand servers determines whether any of the digital video players it serves has requested the content. Based on this determination, the video-on-demand server requests the live video feed from the broadcast server. The video-on-demand server may perform this requesting step by subscribing to a multicast group associated with the live video feed.

In various implementations, the system may include an Ethernet switch communicatively linked to each of the video-on-demand servers and to the broadcast server. The Ethernet switch maintains the subscriptions to any multicast groups. In one implementation, the video-on-demand servers receive the content from the broadcast server only if the video-on-demand server determines that one of the digital video players it servers has requested the content. The video-on-demand servers may request the content from the broadcast server by using a multicast protocol. Each digital video player may request the content in response to receiving an input from a passenger via an interactive menu.

In yet another embodiment of the invention, the method includes the steps of receiving a satellite television signal at a receiver on an aircraft, in which satellite signal comprising data representing a live television broadcast; and transmitting the data to a broadcast server on the aircraft. The broadcast server multicasts the data over a network to video-on-demand servers on the aircraft. Each video-on-demand server is associated with a group of digital video players, and each digital video player is associated with a passenger seat of the aircraft. Each of the video-on-demand servers determines which of its associated digital video players has requested the television broadcast and then multicasts the data to those digital video players. In one implementation, each of the video-on-demand servers subscribes to a multicast group only if one or more of its digital video players requests the data. A virtual local area network that includes the broadcast server and the video-on-demand servers may be maintained to carry out the method.

### BRIEF DESCRIPTION OF THE DRAWINGS

FIG. 1 illustrates an embodiment of the system for delivering on-demand video described herein;

FIG. 2 illustrates an embodiment of a VOD server (from FIG. 1);

FIG. 3 illustrates an embodiment of an area distribution (ADB) box (from FIG. 1);

FIG. 4 illustrates an embodiment of a seat electronics box (SEB) (from FIG. 1); and

FIG. 5 is a block diagram that will be referred to in conjunction with a description of the steps carried out on the system of FIG. 1 to deliver both on-demand video and a broadcast program to passengers on an airline.

### DETAILED DESCRIPTION

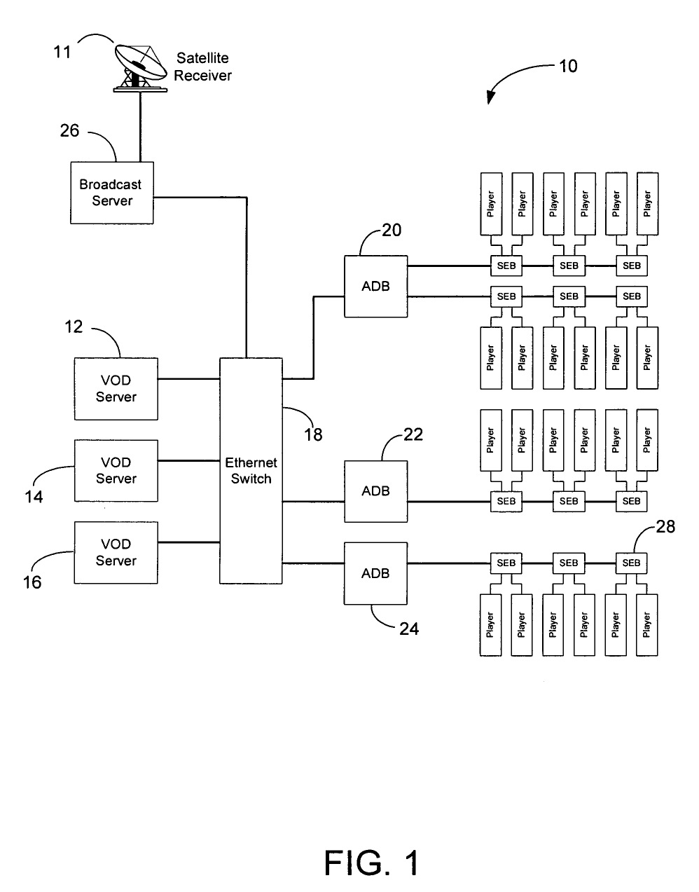

Referring to FIG. 1, a system configured in accordance with an embodiment of the invention is shown. The system, generally labeled 10, is an Ethernet network (e.g., 100 BaseT or 1000 BaseT) located on a passenger aircraft, and having several components, many of which act as nodes on the network. Although the embodiment described herein will be referred to as having a certain number of each type of component, it is to be understood that any number of nodes and/or components is possible. The system 10 includes a satellite receiver 11, first, second, and third VOD servers 12, 14, and 16, and an Ethernet switch 18. The satellite receiver 11, and the VOD servers 12, 14, and 16 are communicatively linked to the Ethernet switch 18 via Ethernet communication links. The Ethernet switch 18 directs Ethernet frames to the appropriate components in the system 10 based on one or more of the following: MAC addresses of the frames, multicast protocols, broadcast protocols, and IP addresses of the IP packets contained within the Ethernet frames. The system 10 also includes first, second, and third area distribution boxes (ADBs) 20, 22 and 24, each of which is communicatively linked via Ethernet to the Ethernet switch 18. Proximate to each row of passenger seats in the aircraft is a seat electronic box (SEB) 28, which is communicatively linked to one of the ADBs via Ethernet. One or more digital video players (“players”) are connected to each SEB via gigabit Ethernet such that each passenger will have his or her own player. Each player may be stand-alone, or may be integrated with a video display unit, such as the Smart Video Display Unit (SVDU) described in U.S. application Ser. No. 11/137,011, which was filed on May 25, 2005, and is incorporated herein by reference in its entirety. The system further includes a broadcast server 26, which is communicatively linked via Ethernet to the first, second, and third VOD servers 20, 22, and 24, and to the satellite receiver 11. In an embodiment of the invention, the Ethernet switch 18 limits distribution of the content of the broadcast server 26 to the VOD servers 20, 22, and 24 by, for example, setting up a port-based Virtual Local Area Network (VLAN).

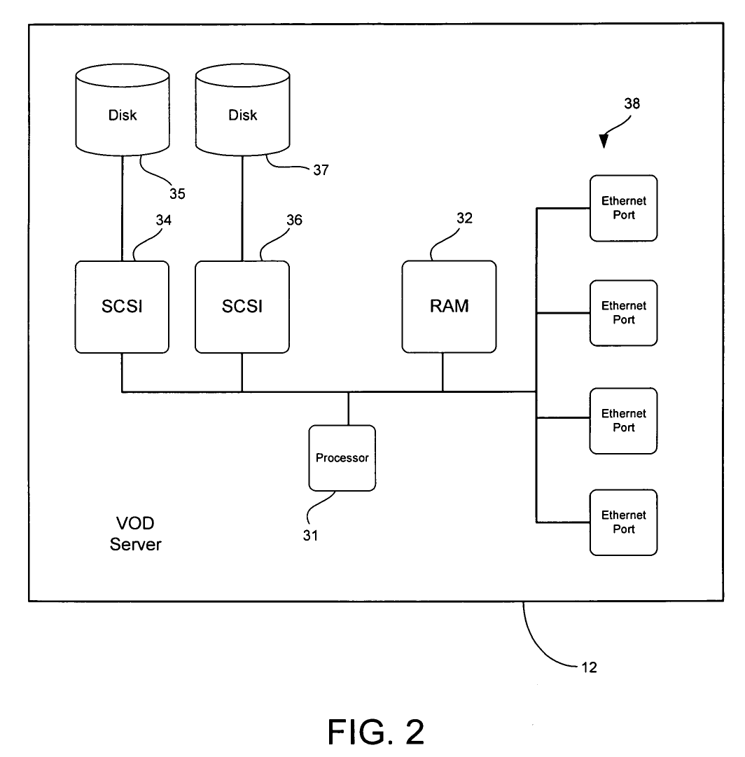

Referring to FIG. 2, an example implementation of a VOD server (the VOD 12 from FIG. 1) will now be described. According to this implementation, each VOD server is controlled by a processor 31 (e.g., a 300 MHz G3 PowerPC), and includes a Random Access Memory (RAM) 32, a first controller (e.g., a SCSI controller) 34, a first hard disk 35, a second controller 36, and a second hard disk 37. The VOD server further includes Ethernet interfaces 38. The operation of the first hard disk 35 is controlled by the first controller 34, while the operation of the second hard disk 37 is controlled by the second controller 36.

Stored on the first and second hard disks 35 and 37 is data representing video content (including any accompanying audio content), such as movies and prerecorded broadcasts. The video content may be stored in any of a variety of formats, MPEG-4 being one example. Also stored on the first and second hard disks 35 and 37 is live broadcast content (i.e., broadcast content that has just been received via television or radio signals). When the VOD server receives a request for video content, the processor 31, in cooperation with the RAM 32 and the controllers 34 and 36, retrieves the video content from one or both of the hard disks 35 and 37, and transmits the video content out of the appropriate Ethernet interfaces 38, buffering the video content as necessary in a video buffer of the RAM 32.

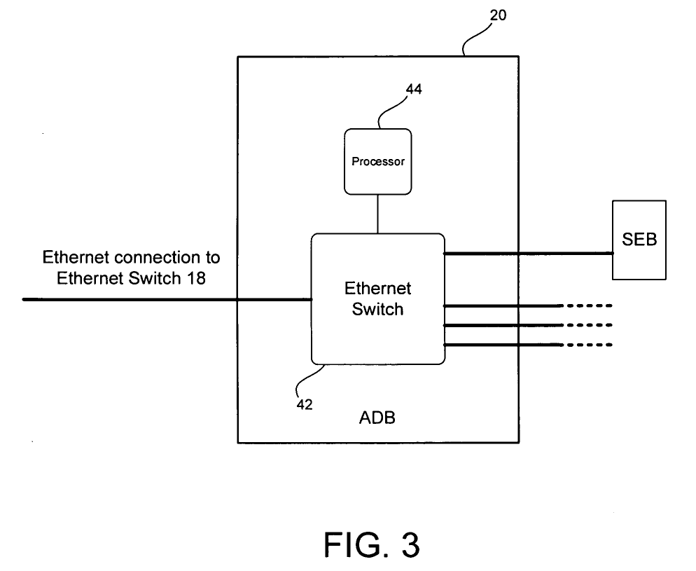

Referring to FIG. 3, an example implementation of an ADB (the ADB 20 from FIG. 1) will now be described. According to this implementation, the ADB is controlled by a processor 44 (e.g., a 300 MHz G3 PowerPC), and includes an Ethernet switch 42. The ADB is communicatively linked to the Ethernet switch 18 (FIG. 1) via a 1000 BaseT Ethernet. The ADB is communicatively linked to some of the SEBs 28 (FIG. 1) in its subnet via Ethernet links (either 1000 BaseT or 100 BaseT). The ADB receives Ethernet frames from the Ethernet switch 18 and transmits them to the appropriate SEBs based on the destination MAC addresses of the frames and based on multicast protocol commands received. Additionally, the ADB may be capable of detecting IP addresses of packets contained within the Ethernet frames and transmitting the Ethernet frames to the appropriate SEBs based on those IP addresses.

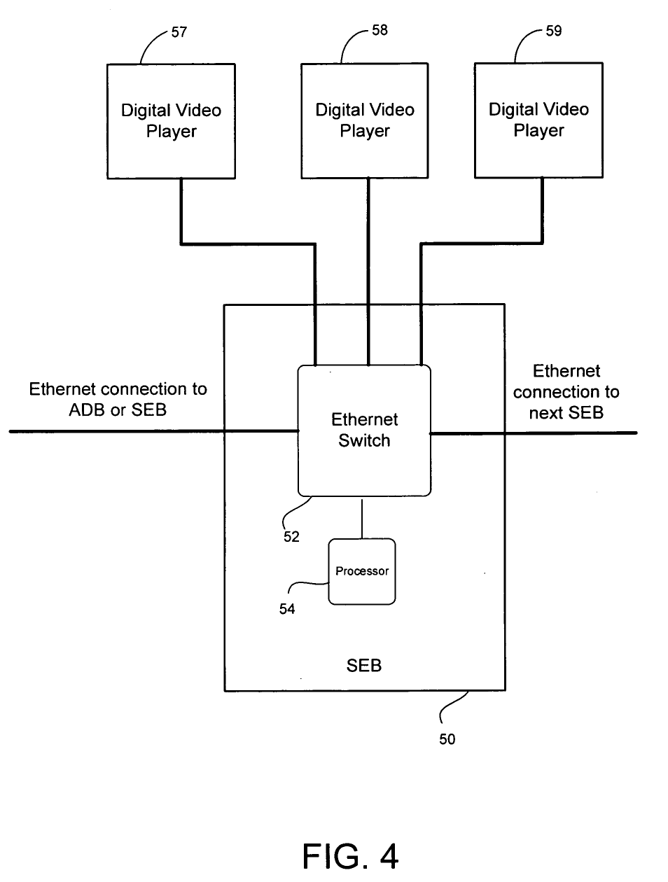

Referring to FIG. 4, an example implementation of an SEB (the SEB 28 from FIG. 1) will now be described. According to this implementation, the SEB is controlled by a processor 54 (e.g., a 300 MHz G3 PowerPC), and includes an Ethernet switch 52. The SEB is communicatively linked to either the Ethernet switch 18 (FIG. 1) or another SEB via an Ethernet link (either 1000 BaseT or 100 BaseT). The SEB is also communicatively linked to first, second, and third players 57, 58, and 59 via 100 BaseT Ethernet. The SEB receives Ethernet frames from the Ethernet switch 18, either directly or via other SEBs, and transmits them to the appropriate digital video player based at least in part on the destination MAC addresses of the frames and based on multicast protocol commands received. Additionally, the SEB may be capable of detecting IP addresses of packets contained within the Ethernet frames and transmitting the Ethernet frames to the appropriate dig based on those IP addresses.

In an embodiment of the invention, the system 10 (FIG. 1) provides broadcast content to the passengers as follows. When an player (in response to a passenger's input) requests a program of the kind provided by the broadcast server 26, the VOD server that normally provides VOD material to that passenger's player looks for the multicast stream associated with the requested program. The data from the multicast stream is then routed as a unicast stream to the requesting player. From the point of view of the system 10, the unicast stream is just another VOD program, just like those that are pre-stored in the VOD servers. The additional load on the VOD server is minimized as the VOD server only listens to the multicast streams explicitly requested by player. The performance impact on the network interface of the VOD server is also minimal as there is virtually no load on the input link to the VOD server when a VOD program is being played.

According to an embodiment of the invention, the broadcast server 26 multicasts its content to one or more predefined “multicast groups,” whose members are one or more of the VOD servers 12, 14, and 16. The identities of the VOD servers that are members of a particular multicast group are defined by and stored on the Ethernet switch 18. The Ethernet switch 18 redirects the multicast streams that it receives from the broadcast server 26 to the appropriate VOD servers based on their membership in the multicast groups.

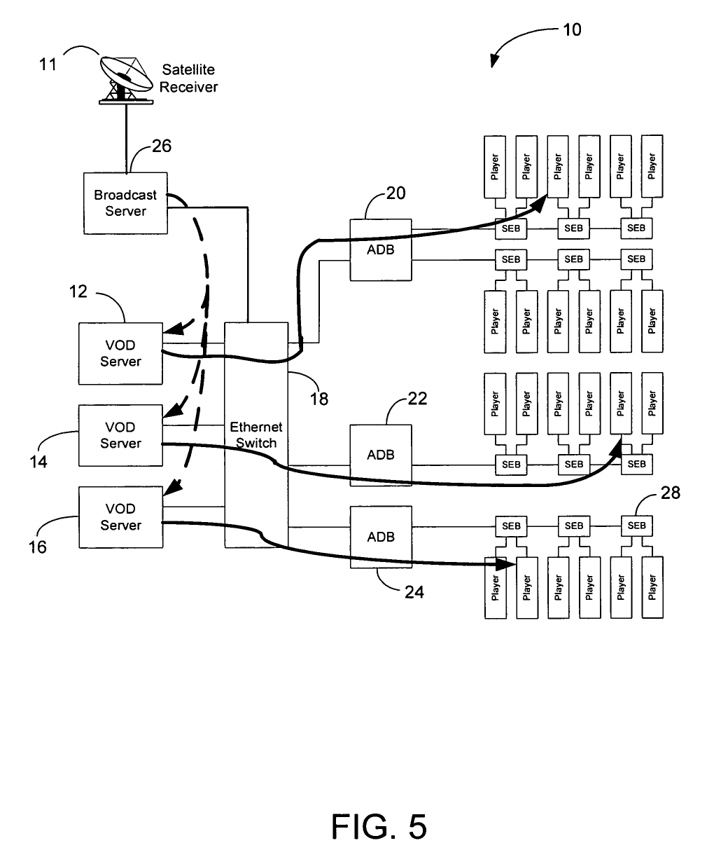

Referring to FIG. 5, an example of how multiple passengers in an aircraft can view both VOD content and broadcast content will now be described. In this example, it is assumed that the broadcast server monitors five different satellite channels and transmits the content of each of those five channels to the Ethernet switch 18. The Ethernet switch defines five multicast groups—one for each of the five channels. Each of the VOD servers then has the option to subscribe to one or more of these multicast groups using, for example, a multicast protocol.

Continuing with the example, first a passenger at one of the passenger seats uses the player to access an interactive menu. Then, the passenger orders a movie using the menu. That order is formatted by the SEB into an HTTP “POST” command, which is transmitted to the Ethernet switch 18 using standard TCP/IP networking protocols. The Ethernet switch 18 refers to its internal routing table to determine which VOD server should handle the request. In this example, it will be assumed that the first VOD server 12 will handle the request. Based on the routing table, the Ethernet switch transmits the request to the first VOD server 12. The first VOD server 12 interprets the request as a request for satellite channel 3. The first VOD server 12 responds by sending a multicast protocol message to the Ethernet switch 18 indicating that the first VOD server 12 wishes to subscribe to the multicast group corresponding to channel 3. The Ethernet switch 18 then transmits Ethernet frames containing the video for channel 3 that it receives from the broadcast server 26 to the VOD server 12. The VOD server 12, in turn, transmits those Ethernet frames to the player of the passenger that requested channel 3.

It can thus be seen that a new and useful system for delivering on-demand video has been described. Note that there are many possible variations of the embodiments described herein that fall within the scope of the following claims. Additionally, every implementation and configuration described herein is meant to be an example only and should not be taken as limiting the scope of the claims. Also, note that he use of the terms “a” and “an” and “the” and similar referents in the context of describing the invention (especially in the context of the following claims) are to be construed to cover both the singular and the plural. Finally, the steps of all methods described herein can be performed in any suitable order unless otherwise indicated herein or otherwise clearly contradicted by context.

What is claimed is:

1. A system for providing broadcast content over an on-demand video network on an aircraft, the system comprising:
a first computer that receives broadcast video content;
a plurality of digital video players distributed within a passenger seating area of the aircraft;
a second computer that performs steps comprising:
receiving the video content from the first computer; and
providing the video content, on-demand, to a first subset of the plurality of digital video players; and
a third computer that performs steps comprising:
receiving the video content from the first computer; and
providing the video content, on-demand, to a second subset of the plurality of digital video players.

2. The system of claim 1, wherein the first computer performs further steps comprising receiving requests for the video content from each of the first subset of the plurality of digital video players and, in response to the requests, subscribing to a multicast group for the video content.

3. The system of claim 1, further comprising a network switch communicatively linked to the first, second, and third computers, wherein the network switch maintains a routing table, and wherein the network switch routes communication from the first computer to both of the second and third computers based on the routing table.

4. The system of claim 1, wherein the second computer only receives the video content from the first computer if the second computer has detected that there is a demand for the video content by one or more of the digital video players.

5. The system of claim 1, wherein the first computer provides the video content to the second and third computers according to a multicast protocol.

6. The system of claim 1, further comprising a satellite receiver communicatively linked to the first computer, wherein the first computer receives satellite television video signals from the satellite receiver, and wherein the satellite television video signals represent the video content.

7. The system of claim 1, wherein each of the digital video players executes software for presenting a menu to a passenger and receives, from the passenger, a request for the video content.

8. The system of claim 1, wherein the video content is a television broadcast.

9. The system of claim 1, wherein the video content is for a television channel that was requested by one or more of the digital video players.

10. The system of claim 1, further comprising a satellite receiver communicatively linked to the first computer, wherein the first computer receives satellite television video signals from the satellite receiver, wherein each of the digital video players to which the video content is transmitted had previously requested the content, and wherein the satellite television video signals represent the video content.

11. A system for delivering broadcast content over an on-demand video network on an aircraft, the system comprising:
a broadcast server that receives a live video feed and multicasts the content of the feed;
a plurality of video-on-demand servers, each communicatively linked to the broadcast server;
a plurality of groups of digital video players located in a passenger area of the aircraft, each group of the plurality being associated with one of the plurality of video-on-demand servers;
wherein each of the video-on-demand servers performs steps comprising:
determining whether any of the group of digital video players associated with the video-on-demand server has requested the content; and
based on the determining step, requesting the live video feed from the broadcast server.

12. The system of claim 11, wherein each of the video-on-demand servers performs the requesting step by subscribing to a multicast group associated with the live video feed.

13. The system of claim 13, further comprising an Ethernet switch communicatively linked to each of the video-on-demand servers and to the broadcast server, wherein the Ethernet switch maintains the subscription to the multicast group.

14. The system of claim 11, wherein each of the video-on-demand servers comprises a means for storing the content of the video feed.

15. The system of claim 11, wherein each of the video-on-demand servers receives the content only if the video-on-demand server determines that one or more of the group of digital video players associated with the video-on-demand server has requested the content.

16. The system of claim 11, wherein each of the digital video players that requests the content does so by receiving an input from a passenger via an interactive menu.

17. The system of claim 11, wherein the each of the video-on-demand servers requests to receive the content using a multicast protocol.

18. A method for providing the content of a live television broadcast, on-demand, to airline passengers, the method comprising:
receiving a satellite television signal at a receiver on an aircraft, the satellite signal comprising data representing a live television broadcast;
transmitting the data to a broadcast server on the aircraft;
the broadcast server multicasting the data over a network to a plurality of video-on-demand servers on the aircraft, each video-on-demand server being associated with a plurality of digital video players, each digital video player being associated with a passenger seat of the aircraft;
each of the plurality of servers determining which of the associated plurality of digital video players has requested the television broadcast, and multicasting the data to those digital video players of the associated plurality that requested the television broadcast.

19. The method of claim 18, further comprising:
each of the video-on-demand servers subscribing to a multicast group to receive the multicast data from the broadcast server only if one or more of the digital video players with which the video-on-demand server is associated requests the data.

20. The method of claim 18, further comprising maintaining a virtual local area network comprising the broadcast server and the video-on-demand servers.
